(19) United States
(12) Patent Application Publication
(10) Pub. No.: US 2020/0217932 A1
(43) Pub. Date: Jul. 9, 2020

(54) LADAR PACKAGING FOR VEHICLE RANGE SENSORS

(71) Applicant: Continental Automotive Systems, Inc., Auburn Hills, MI (US)

(72) Inventors: Patrick B. Gilliland, Santa Barbara, CA (US); Heiko Leppin, Hergensweiler (DE); Kate Anvick, Cupertino, CA (US)

(73) Assignee: Continental Automotive Systems, Inc., Auburn Hills, MI (US)

(21) Appl. No.: 16/240,311

(22) Filed: Jan. 4, 2019

(51) Int. Cl. G01S 7/481; G01S 17/93; B60W 30/08; G01S 17/89; G01S 7/486

(52) U.S. Cl. CPC G01S 7/4813; G01S 17/936; B60W 2420/52; G01S 17/89; G01S 7/4863; B60W 30/08

(57) ABSTRACT

A vehicle sensor system includes multiple LADAR sensors. Each of the LADAR sensors is configured to detect range within a corresponding field of view and to communicate the detected range to a vehicle systems controller. Each of the LADAR sensors includes a detector array electrically connected to a readout integrated circuit via multiple of metallic bumps. A glass screen is disposed outward of the detector array. A ceramic substrate includes a first indention and a conductive solderable surface mount layer, and one of the readout integrated circuit and the detector array is received in the first indention such that an electrical connection between the detector array and the readout integrated circuit is at least approximately level with the conductive solderable surface mount layer.

### TECHNICAL FIELD

The present disclosure relates generally to focal plane array packaging for utilization in LADAR sensors for automotive vehicles.

### BACKGROUND

Modern vehicles, such as commercially available cars and trucks, include increasingly automated operations. In order to facilitate the automated operations, additional sensors, such as LADAR proximity and range sensors are implemented within the vehicle and provide informational to the general vehicle controller. In order to ensure proper automated control systems, the sensors should be protected from the elements and packaged in a way that reduces the response time of the sensor. Further, in order to increase the cost efficiency, the packaging should be configured in a way that reduces manufacturing costs.

### SUMMARY OF THE INVENTION

In one exemplary embodiment, a Laser Detection and Ranging (LADAR) sensor system includes a first LADAR sensor and a second LADAR sensor, the first LADAR sensor having a detector array electrically connected to a readout integrated circuit via a plurality of metallic bumps, a glass screen disposed outward of the detector array, a ceramic substrate including a first indention and a conductive solderable surface mount layer, one of the readout integrated circuit and the detector array being received in the first indention such that an electrical connection between the detector array and the readout integrated circuit is at least approximately level with the conductive solderable surface mount layer, a laser transmitter with a pulsed laser light output transmitting light at a first wavelength through a diffusing optic adapted to illuminate a reflecting surface in a first field of view of the first LADAR sensor, a time zero reference output connected to the second LADAR sensor through a cable, the time zero reference output adapted to signal the beginning of the pulsed laser light output, the second LADAR sensor having a second field of view overlapping the first field of view, a time zero reference input connected to the cable, a time zero reference circuit connected to the time zero reference input, and the time zero reference circuit having a time zero reference electrical output, and receiving optics adapted to collect and condition the pulsed laser light reflected from the reflecting surface.

In another exemplary embodiment, a vehicle sensor system includes a plurality of LADAR sensors, each of the LADAR sensors is configured to detect range within a corresponding field of view and communicate the detected range to a vehicle systems controller, and each of said LADAR sensors includes a detector array electrically connected to a readout integrated circuit via a plurality of metallic bumps, a glass screen is disposed outward of the detector array, a ceramic substrate including a first indention and a conductive solderable surface mount layer, and one of the readout integrated circuit and the detector array being received in the first indention such that an electrical connection between the detector array and the readout integrated circuit is at least approximately level with the conductive solderable surface mount layer.

These and other features of the present invention can be best understood from the following specification and drawings, the following of which is a brief description.

### BRIEF DESCRIPTION OF THE DRAWINGS

FIG. 1 illustrates an exemplary vehicle including LADAR sensors for tracking other vehicles.

FIG. 2 illustrates an exemplary connection diagram for two long range LADAR sensors within the vehicle of FIG. 1.

FIG. 3 schematically illustrates a block diagram of an exemplary LADAR sensor.

FIG. 4 schematically illustrates an exemplary unit cell circuit for a detector array of the exemplary LADAR illustrated in FIG. 3.

FIG. 5 schematically illustrates an exemplary detector array assembly.

FIG. 6 schematically illustrates a cross section of the exemplary detector array assembly of FIG. 5 according to a first example.

FIG. 7 schematically illustrates a cross section of the exemplary detector array assembly of FIG. 5 according to a second example.

FIGS. 7A-7E illustrate an exemplary floating connector for providing a board to board connection.

FIG. 8 schematically illustrates a cross section of an alternate detector array assembly.

### DETAILED DESCRIPTION

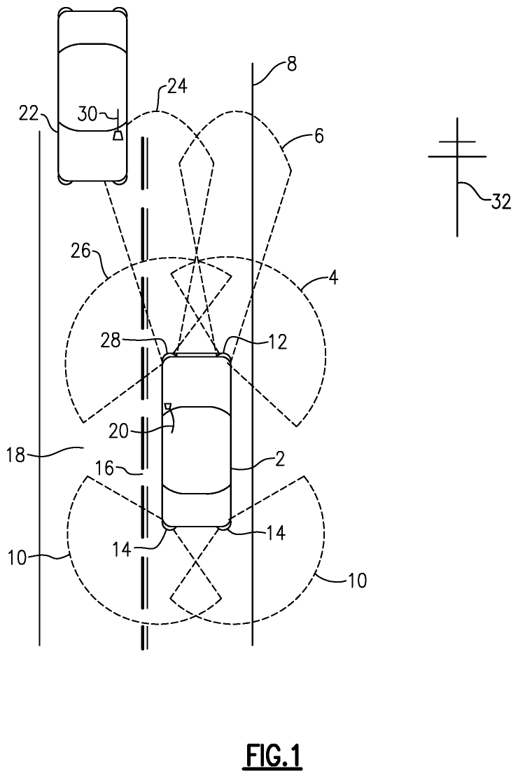

FIG. 1 illustrates an exemplary installation of number of long range LADAR sensors and short range LADAR sensors within a forward looking radome 12 on a vehicle 2. As used herein LADAR refers to a surveying method that measures distance to a target by illuminating the target with pulsed light and measuring the timing of the reflected pulses with a sensor.

The long range LADAR sensors have a field of view 6 for the right side of the vehicle 2, and a field of view 24 for the left side of vehicle 2. The short range LADAR sensors have a field of view 4 for the right side of the vehicle 2, and a field of view 26 for the left side of vehicle 2. The right side LADAR sensors sweep out the lane in front of the vehicle 2 from the center divider 16 up to the right edge of a roadway 8, and significantly overlap these boundaries.

In the example of FIG. 1, an approaching vehicle 22 enters the field of view 24 of the left side long range LADAR sensor housed within the left radome 28. The short range LADAR sensor housed within the left radome 28 has a field of view 26, which monitors the adjacent lane 18 and the roadway surface. A radio link communicates through an antenna 20 to other vehicles 22 on the road having similar equipment 30, and to traffic control antennas 32 placed along the roadway. Rearward facing LADAR sensors are housed within rear radomes 14 and have a field of view 10 which provides information during backup maneuvers, and information on vehicles approaching from the rear of vehicle 2. The rearward facing LADAR sensors function similarly to the short and long range LADAR sensor in the forward looking radomes 12, 28. In all events the LADAR sensors within the radomes 12, 14, 28 allow light from a pulsed light source to be emitted and then allow reflections of the pulsed light to be received, through a focal array within the radome 12, 14, 28.

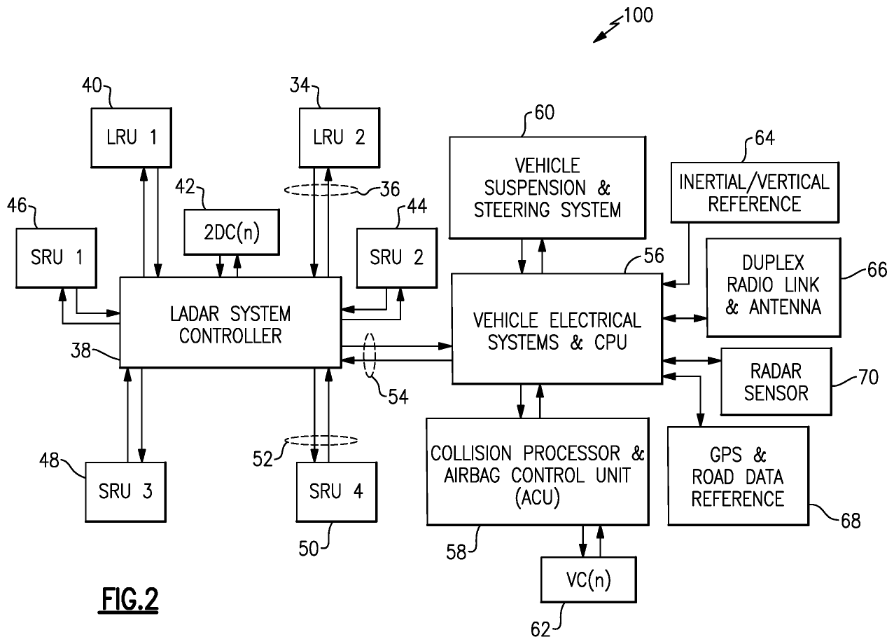

With continued reference to FIG. 1, FIG. 2 illustrates a system diagram 100 for the vehicle 2 showing the connection of the two long range LADAR sensor units 34 and 40 with a system controller 38 within the vehicle 2. The system controller 38 controls the operation of, and monitors the status of, all the LADAR sensors in the vehicle 2. Control and status monitoring is effected through a set of bidirectional connections 36 connecting the sensors to the system controller 38. The bidirectional connections 36 may be electrical connections, optical connections, or a combination thereof. The system controller 38 also controls short range LADAR sensors 44, 46, 48, and 50 through a set of corresponding bidirectional connections 52. A number of conventional 2D cameras 42 are also connected bidirectionally to the system controller 38. In alternative examples, any alternative imaging system can be used in place of the conventional 2D cameras 42. The system controller 38 may also process data from the LADAR sensor units 34, 40 and 2D cameras 42, or may pass the data through to a vehicle CPU 56 via bidirectional connections 54. The vehicle CPU 56 connects to the many other electrical subsystems (illustrated as incorporated within the vehicle CPU 56) in the vehicle 2.

A separate collision processor 58, including an airbag control unit, is configured to determine when to deploy airbags and/or other impact mitigation technologies once an impact is unavoidable, and is connected bidirectionally with the vehicle CPU 56. A number of video cameras 62 are connected to, and support, the collision processor 58. In some examples, the collision processor 58 can forward this video data to the vehicle CPU 56 as well. The vehicle CPU 56 connects to the vehicle suspension and steering system 60 through bidirectional connections and power electronics which are illustrated together with the CPU 56. An inertial reference and vertical reference are shown together logically as a reference 64, and each give reference data to the vehicle CPU 56. A duplex radio link 66 operates through the antenna 12 in FIG. 1, to allow the vehicle 2 to communicate cooperatively with other vehicles 22 on the road, and with fixed antennas 32 to augment the autonomous capability provided by the vehicle LADAR, RADAR 70, and video sensors 42, 62.

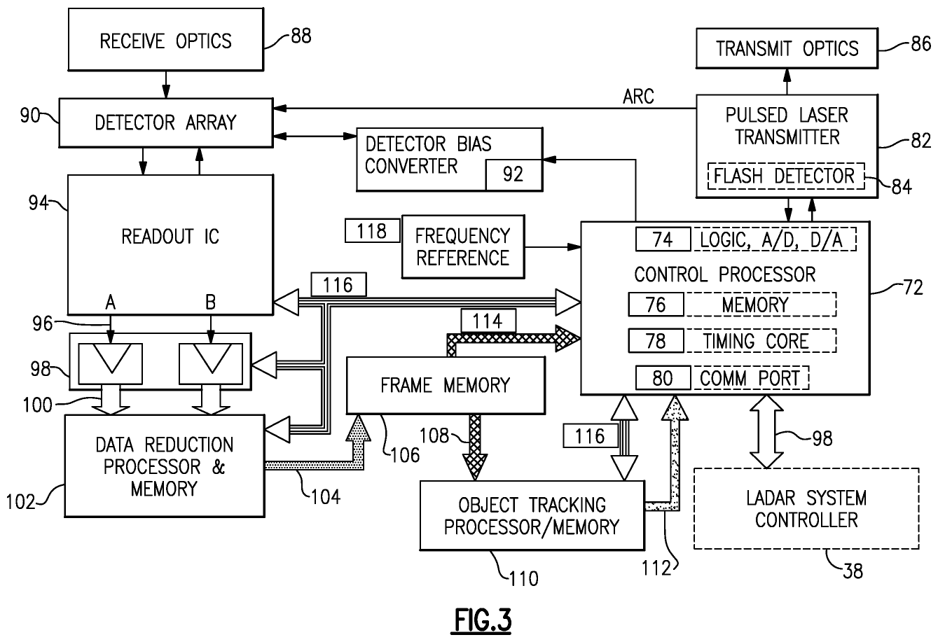

FIG. 3 is a block diagram of a LADAR sensor which may be either a long range LADAR sensor 34, 40 or a short range LADAR sensor 44, 46, 48, 50. The primary difference between a long range and short range LADAR sensor is the power transmitted by the illuminating laser, and the power of the receiving optics. A control processor 72 initiates a range measurement by issuing a command to a pulsed laser transmitter 82 causing the pulsed laser transmitter 82 to emit a pulse. The control processor 72 interfaces with the laser transmitter 82 through bidirectional connections and an interface circuit 74. The bidirectional interface circuit 74 contains logic, level shifters, and digital to analog (D/A) converters for controlling and initiating the laser pulse. The interface circuit 74 also provides analog to digital (A/D) converters for monitoring temperature, transmitted power, and other analog indicators returning from pulsed laser transmitter 82.

The control processor 72 includes an internal memory 76 storing a program and any necessary calibration and control constants. Also included in the control processor 72 is a timing core 78. The timing core 78 synthesizes and controls the phase of all the clocking frequencies in the LADAR subsystems. The control processor 72 also includes a communications port 80 for communicating with the host vehicle 2. The communication port 80 in the example of FIG. 3 is one of Ethernet, CAN, Fibre Channel, USB, IEEE1394, or any other standard protocol. In alternatively examples, a proprietary interface can be utilized in place of a standard protocol to the same effect. The pulsed laser transmitter 82 has a power monitoring photodiode 84, which detects the illuminating flash of pulsed laser transmitter 82 by intercepting a small portion of the laser power, typically at the rear facet of the laser. The signal from the photodiode 84 is provided to control processor 72 as confirmation the pulsed laser transmitter 82 is operating properly, as a diagnostic, or both. Transmit optics 86 diffuse the light to illuminate the field of view in the patterns 4, 6, 10, 24, 26, etc. as shown in FIG. 1.

When the pulsed laser light is reflected by an object in a field of view of the corresponding LADAR sensor, for example the second vehicle 22 in FIG. 1, the receive optics 88 of the receiving LADAR sensor collect and concentrate the light on a detector array 90 within the LADAR sensor. By way of example, the receiving optics typically include a lens that focuses the reflected light onto the detector array 90. The lens system 88 focuses light onto the plane of the surface of the 2D array of photodetectors comprising detector array 90, thus the term focal plane array is often used to describe detector array 90.

The detector array 90 is operated in a photoconductive mode, and is typically placed under a reverse bias generated by an electrical connection to a detector bias converter 92. The detector bias convertor 92 is controlled by a control processor 72. An optical sample of the transmitted laser pulse (ARC) may be provided to a few pixels of the detector array 90 via an optical waveguide, and function as a time zero reference indicating the timing of the laser pulse emission.

Each detector element of the detector array 90 produces an electrical current pulse in response to the reflected light pulses. The electrical current pulses from each detector element of the detector array 90 are electrically connected to a unit cell circuit of readout IC 94 (ROIC 94) via a metallic bump. Each unit cell circuit of ROIC 94 amplifies and detects the incoming current pulses, and may take a series of analog samples of the current waveform. At the end of each acquisition cycle, the ROIC 94 transmits the analog samples through connections 96 to a number of analog to digital converters 98. The A/D converters 98 transmit their outputs via digital connections 100 to a data reduction processor 102. The data reduction processor 102 forms an initial estimate of the range to each reflecting object in the field of view for all pixels in the detector array 90.

The example of FIG. 3 includes two analog channels, and two A/D converters, but practical embodiments may include four, eight, or greater sets of analog channels and A/D converters. The digital range representations of the sensor are read out from data reduction processor 102 through a digital interface 116. In the illustrated embodiment, the digital interface 116 can also be used as a control bus between readout cycles, and prior to the next transmit and acquisition cycle. The digital interface 116 connects control processor 72 with the ROIC 94, A/D converters 98, and data reduction processor 102. The digital interface 116 is also used to return range data and status information of the dependent modules 94, 98, and 102. The data reduction processor 102 receives data representing the values of the analog samples taken by ROIC 94 and operates on the received data using an algorithm configured to extract and refine the time of arrival of the current pulses produced by the detector array 90.

In some examples, the algorithm is in the form of a matched filter, designed to match the characteristics of the transmitted laser pulse. In other examples, other algorithm types may be used depending on the needs and configuration of the specific embodiment. The data reduction processor stores some number of samples internally in a memory circuit to facilitate digital operations on multiple samples and multiple pixels, and then transmits the refined range data to a frame memory 106 via a data bus 104.

A frame memory 106 holds a minimum of a full frame of range data (the equivalent of one complete 3D still image) and transmits the data to the control processor 72. The control processor 72 then forwards the range data through a communications port 80, via bidirectional connections 98, to the LADAR system controller 38 or to a designated vehicle CPU 56. Frame memory 106 also transmits the range data to an object tracking processor 110 via a data bus 108. The object tracking processor 110 can be present within some LADAR sensors as in the exemplary embodiment. Alternatively, the object tracking processor 110 can be embedded in a higher level processing unit of vehicle 2, such as the vehicle CPU 56. The object tracking processor 110 identifies and tracks any number of objects in the field of view of the LADAR sensor, and communicates these vectors to control processor 72 via a data bus 112.

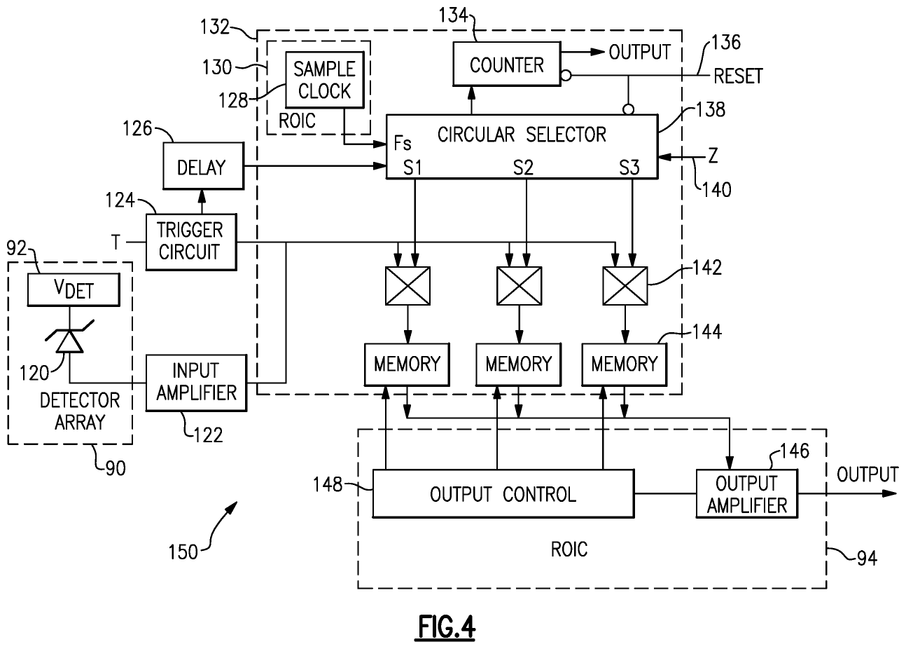

FIG. 4 illustrates a schematic embodiment of a unit cell circuit of the ROIC 94 including the detector array 90 which includes individual detector elements 120. The individual detector elements 120 are arranged in a rectangular array of 32 rows and 128 columns in the example of FIG. 4. Alternative embodiments can include alternative array configurations. Each detector element 120 produces an electrical current pulse in response to an incoming light pulse. The anode of each detector element 120 connects to an input amplifier 122. The input amplifier 122 is, in some examples, a transimpedance amplifier. The output of the amplifier 122 drives a trigger circuit 124, and a number of analog sampling gates 142. The trigger circuit 124 is, in some examples, a Schmitt trigger and changes state from low to high when the analog voltage output of amplifier 122 exceeds an input threshold (T) supplied by the ROIC 94.

The output of the trigger circuit 124 is delayed by a delay generator 126, and connects to a deselect input of circular selector 138. When the circular selector 138 is deselected, the select outputs S1, S2, S3, are deactivated. In one example, the analog sampling gates 142 are transmission gates, or analog switches. The analog sampling gates 142 are selected in order by circular selector 138 in a sequence whenever a transition of sample clock 128 is present at the “Fs” input. In this way, during a given acquisition cycle, analog memory cells 144 are each in turn charged to the analog voltage present at the output of amplifier 122 through the analog sampling gates 142, and the analog waveshape of amplifier 122 output is captured. Only three sampling gates and analog memory cells are illustrated for the sake of clarity, however practical implementations can include 128, or any other number, and be functional. The process occurs continuously until the trigger circuit 124 detects a pulse and freezes the circular selector, terminating the analog sampling process. The analog memory circuit 144 is, in some examples, a capacitor having a second terminal connected to analog ground. The capacitance of the analog memory circuit 144 is sufficient to prevent any noticeable droop in the analog power level prior to a readout cycle.

A counter 134 monitors the number of transitions of the circular selector 138, allowing a preliminary determination of range based on the value in the counter, as each of the transitions are occasioned by a cycle of a sample clock 128. A reset input 136 is asserted after the readout cycle and prior to the succeeding acquisition period. An impedance control 140 (Z) causes the actuation voltage of the select outputs S1-S3 to be variable, providing for in-phase and quadrature (I & Q) phase detection when the laser is a modulated semiconductor laser instead of a pulse laser. The dashed line 132 encloses the circuit elements used to produce a sampling subsystem, which may be replicated any number of times within the unit cell 150. The readout cycle is controlled by an output control 148, which selects each memory cell in sequence for connection to the input of output amplifier 146. The output amplifier 146 drives the analog sample voltages to the boundary of the IC. In the illustrated example, elements of the ROIC 94 are shown within dashed lines, including the sample clock 128, the output control 148, and the output amplifier 146. Elements of the detector array 120 and detector bias voltage 92 are also shown within dashed lines line 90 as being outside the unit cell circuit 150.

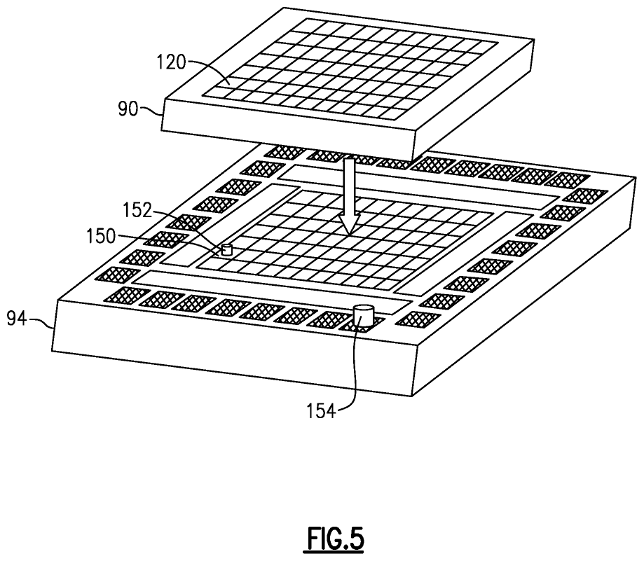

FIG. 5 schematically illustrates a connection of an exemplary detector array 90 that is connected to the ROIC 94 via metallic interconnect bumps 152. While a single metallic interconnect bump 152 is illustrated in FIG. 5 for explanatory purposes, one of skill in the art will appreciate that each grid square will include a corresponding metallic interface bump 152. Also included in the assembly are a second set of metallic bumps 154. The second set of metallic bumps 154 are typically gold stud bumps, copper pillars, and the like, and are formed on ROIC 94 prior to singulation of the ROIC 94 into die form. The second set of metallic bumps 154 are used for connection of ROIC inputs and outputs to a host substrate on the ROIC 94. Only one metallic interconnect bump 152 and one bump 154 are shown here for clarity, though each unit cell 150 will have one or more metallic interconnect bump 152, and each I/O pad will have a corresponding bump in the second set of metallic bumps 154. Alternatively, metallic bump 154 may be replaced by a wirebond of gold, copper, or aluminum wire for interconnecting the ROIC to a supporting circuit substrate. In one example, the metallic bump 152 is constructed at least partially of indium. In alternative examples the metallic bumps 152 can be gold, copper or any other suitable conductive material. The bumps in the second set of metallic bumps 154 are often tipped with a Sn/Ag solder compound, for thermocompression style bonding. The exemplary Figure illustrates individual detector elements 120 in a 7×11 element array. Alternative examples can utilize alternative array configurations.

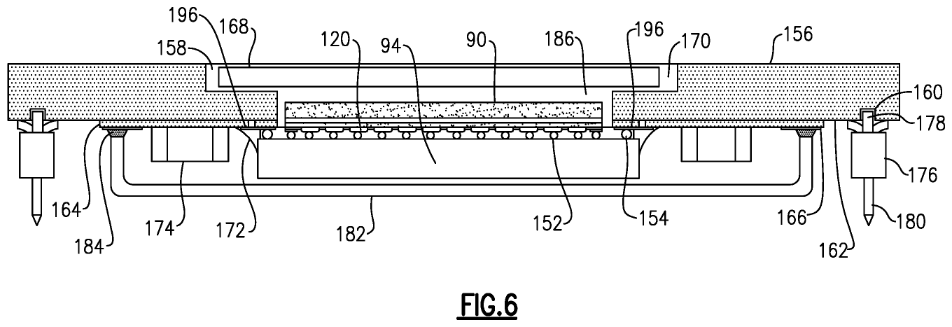

With continued reference to the assembly of FIG. 5, FIG. 6 illustrates a cross sectional view of a focal plane array package configured to be fully assembled in panels, making maximum use of efficient assembly robots. A ceramic substrate 156 is dry pressed from ceramic powder materials. In some examples the ceramic powder materials can include alumina or aluminum nitride. A recess 158 is formed during the dry press process, and a rectangular through port 186 is similarly formed by the dry pressing die. In alternative examples, such as the example of FIG. 8 (described below) the through port 186 can be replaced with a rectangular indention, or recess.

Multiple circular recesses 160 are also formed at the same time by the dry press die. Alternatively, the recesses 160 may be laser drilled in the fired and finished ceramic blank, or after metallization, to ensure precision in mounting connector body 176. The dry pressed ceramic blank is fired, and lapped/polished as required to produce a uniform, flat surface for further processing. A first thick film conductor layer 162 is printed and fired, and an insulating thick film layer 164 is then printed and fired. Any number of thick film conductor and insulating layers may be formed in this manner, depending on circuit complexity, but the exemplary embodiment requires only six, including a cap layer 166. The cap layer 166 is a conductive solderable surface. Conductive layers may be constructed of palladium/silver, gold, etc., or any suitable thick film metal system. Insulating layers are typically alumina or aluminum nitride. The cap layer 166 is approximately level with the connection to the detector array, allowing for an almost 2D assembly process. The combination of the cap layer 166 and the thick film conductor and insulating layers create a substrate for attaching surface mount components to the IC.

A window 168 is fit into recess 158 in the through port 186 using a glass frit powder 170 which is then reflowed in a high temperature oven. This fit allows the window 168 to be fixed in place via the glass ceramic joint formed by the reflow of a glass compound onto the ceramic blank. The glass/ceramic joint forms a seal which can be more reliable or easier to manufacture than conventional glass-metal joints. The window 168 is the focal plane and allows and directs reflected light from the emitted light pulses to strike the detector array 90.

A mounting surface of the ceramic 156 is a surface opposite the window 168, and surface mount components 174 are mounted to the mounting surface. The surface mount components 174 can be capacitors, inductors, resistors, small integrated circuits, bare chip LEDs, lasers, discrete detector dies, or any other surface mount component 174. An insulating pin strip connector body 176 is installed in two rows, with a locating pin 178 engaging with recess 160 to provide precision location of the pins. Surface mount leads 180 are bent where they mate with the first thick film conductor layer 162. The surface mount components 174 and connector are then solder reflowed in a five zone or seven zone reflow oven.

Attachment of the detector 90 and ROIC 94 hybrid subassembly follows, using the gold stud bumps 154 and thermosonic bonding to attach the assembly to mating thick film circuit traces on the ceramic substrate 156. In thermosonic bonding, the ceramic substrate 156 can be heated to 100 C, and the ROIC 94 flip-chip is mounted with ultrasonic energy activating the placement head, to reflow gold stud bumps 154. An epoxy fillet is then dispensed, bridging between ROIC 94 and ceramic substrate 156, and cured. The epoxy fillet extends the full perimeter of ROIC 94, effectively sealing the through port 186 containing detector array 90. A hermetic seal is effected by the addition of a deep drawn Kovar cover 182, which is pre-tinned and soldered using a hot tool, IR, or laser reflow, forming solder fillet 184. Solder fillet 184 forms a continuous unbroken seal around ROIC 94 and some portion of the surface mount parts.

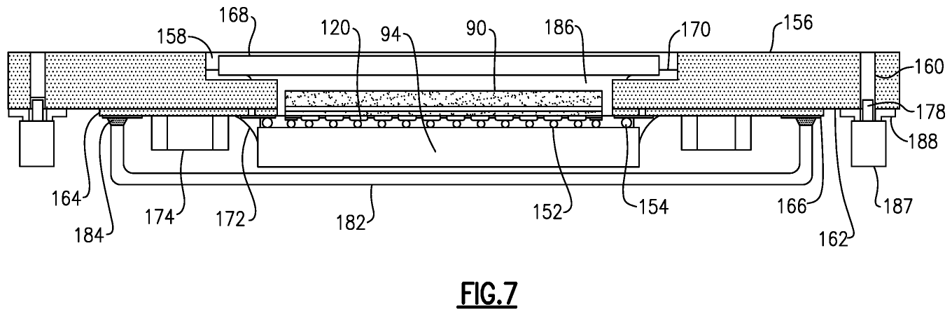

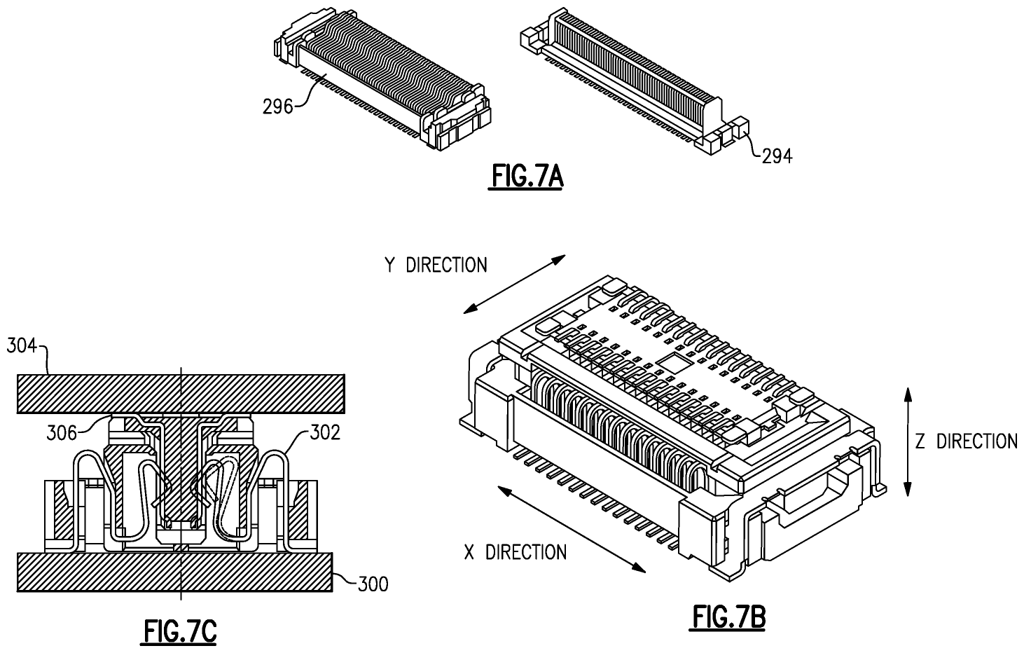

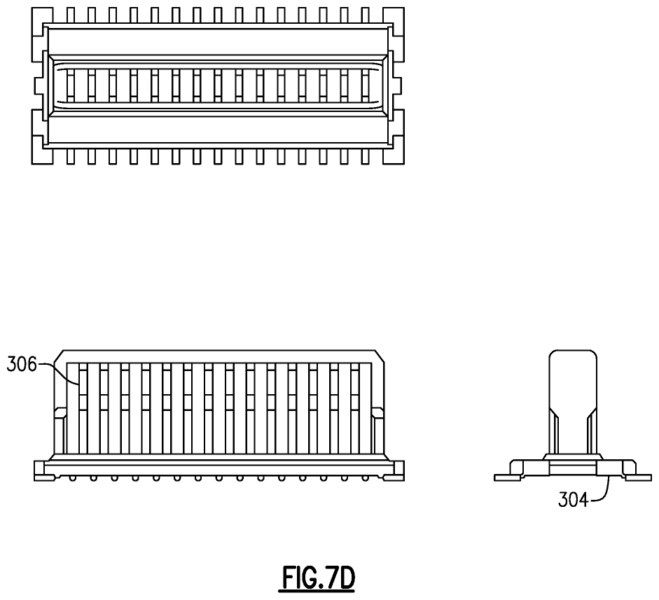

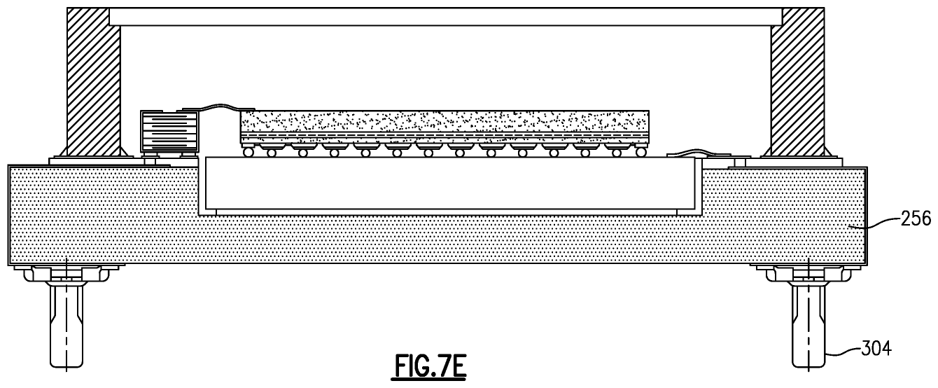

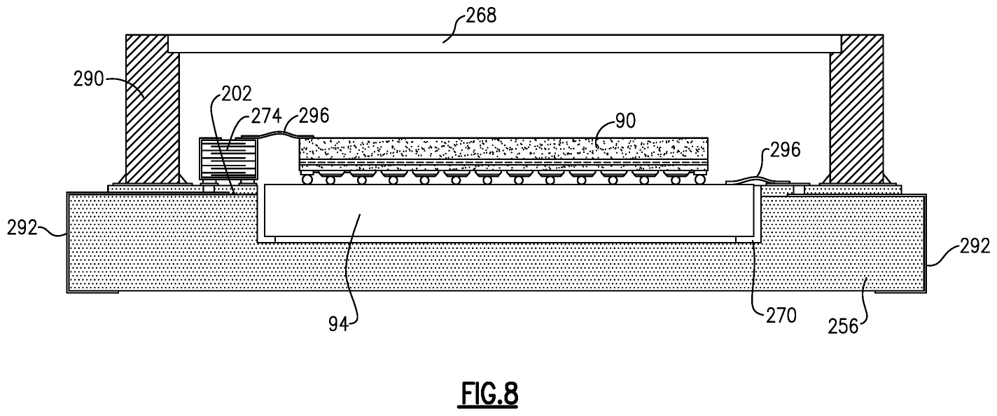

With continued reference to FIG. 6, FIG. 7 schematically illustrates a cross section of FIG. 5 with the utilization of an alternative connector form 180. In the alternative form, the connector 180 includes a socket body 187 having flat surface mount leads 188 inserted therein, and a locating pin 178 engaged with a precision laser drilled through hole 160. Mating connector pins are mounted on a host PCB (not shown but similar to 180). While illustrated on distinct embodiments, one of skill in the art will appreciate that the varied connectors of FIGS. 6 and 7 could both be used simultaneously in a single embodiment.

A third type of connector body is a floating board-to-board style. In one example, a floating board-to-board style connector body that could be used is an Iriso 3 mm floating connector. A floating board-to-board connector allows for misalignments of the optical axis and the electronics supporting the printed circuit board (PCB) within the housing of a ladar sensor 34 or 46.

With continued reference to FIGS. 1-6, FIG. 7A illustrates an isometric view of an existing Iriso floating board-to-board connector, which can provide for reliable connection between socket 296 and plug 294 even though there may be several tenths of a millimeter of offset in the x and y axes. Similarly, FIG. 7B illustrates an isometric drawing of the mated assembly 298 of plug 294 and socket 296. FIG. 7C illustrates a cross-section of the mated assembly 298, indicating plug body 304, plug contacts 306, socket body 300, and socket contacts 302, formed in a complex double-S bend. This arrangement allows for a considerable offset in the x, and y relative locations of the mating parts, but other board to board (B2B) connectors may be used with similar results. FIG. 7E illustrates the installation of a floating B2B style connector, with body 304 mounted on the mating surface of ceramic substrate 256, for mating to a host circuit assembly. The example connections of FIGS. 7A-7E are non-limiting in nature, and alternative board to board or floating connector types could be used to the same effect.

With continued reference to FIGS. 5-7, FIG. 8 illustrates a cross sectional view of the example of FIG. 5 using a partial indent 270 in the ceramic substrate 256 in place of the port 186 of FIGS. 6 and 7. As the ceramic substrate 256 does not include a through port, the glass cover acting as the focal array is elevated off the substrate 256 to provide space for the detector array 90.

To support the glass cover 268, and provide a hermetic seal around the detector array 90, a metal support structure 290 in the form of a rectangular ring, protrudes from the ceramic substrate 256. The glass cover 268 is received in a groove in the metal support structure 290, and the metal support structure substantially surrounds the glass cover 268. The glass cover 268 is joined to the metal support structure 290 via any type of glass-metal joining including solder, frit seal, or epoxy. In order to provide electrical communication from the surface mount side 202 to the reverse side of the substrate, a wraparound contact 292 is provided on at least one edge of the ceramic substrate. The example of FIG. 8 may also be used with either style of connector body 176, 187, or the floating B2B style connector 304.

With reference to the examples of FIGS. 6-8, the impedance generated by the connections between the detector array 90, the ROIC 94, and the various surface mounted components 274 is reduced by placing the connection points within the same plane, or approximately within the same plane. This substantially reduces the length of the connecting bondwires 196, 296. Further, due to the placement within the plane of the surface mount components 174, 274, the connecting bondwires and the surface mount components can be assembled in an almost purely two dimensional assembly process in the examples of FIGS. 6 and 7, and a substantially two dimensional assembly process in the example of FIG. 8.

It is further understood that any of the above described concepts can be used alone or in combination with any or all of the other above described concepts. Although an embodiment of this invention has been disclosed, a worker of ordinary skill in this art would recognize that certain modifications would come within the scope of this invention. For that reason, the following claims should be studied to determine the true scope and content of this invention.

1. A Laser Detection and Ranging (LADAR) sensor system comprising:
a first LADAR sensor and a second LADAR sensor;
said first LADAR sensor having;
a detector array electrically connected to a readout integrated circuit via a plurality of metallic bumps;
a glass screen disposed outward of the detector array;
a ceramic substrate including a first indention and a conductive solderable surface mount layer;
one of the readout integrated circuit and the detector array being received in the first indention such that an electrical connection between the detector array and the readout integrated circuit is at least approximately level with the conductive solderable surface mount layer;
a laser transmitter with a pulsed laser light output transmitting light at a first wavelength through a diffusing optic adapted to illuminate a reflecting surface in a first field of view of said first LADAR sensor,
a time zero reference output connected to said second LADAR sensor through a cable, said time zero reference output adapted to signal the beginning of the pulsed laser light output,
said second LADAR sensor having;
a second field of view overlapping said first field of view,
a time zero reference input connected to said cable,
a time zero reference circuit connected to said time zero reference input, and said time zero reference circuit having a time zero reference electrical output, and
receiving optics adapted to collect and condition the pulsed laser light reflected from said reflecting surface.

2. The LADAR sensor system of claim 1, wherein the first indention includes a port and a ledge.

3. The LADAR sensor system of claim 2, wherein the detector array is disposed within the port, and wherein the glass screen is mounted to the ledge.

4. The LADAR sensor system of claim 3, wherein the glass screen is connected to the ceramic substrate via a glass ceramic joint.

5. The LADAR sensor system of claim 2, wherein the solderable surface mount layer is disposed on a side of the substrate opposite the glass screen.

6. The LADAR sensor system of claim 1, wherein the first indention extends partially into the ceramic substrate.

7. The LADAR sensor system of claim 6, wherein the readout integrated circuit is disposed within the indention, and where the detector array is exterior to the indent.

8. The LADAR sensor system of claim 6, further comprising a support structure extending outward from the solderable surface mount layer and receiving the glass screen.

9. The LADAR sensor system of claim 8, wherein the support structure is a metal support structure.

10. The LADAR sensor system of claim 9, wherein the glass screen is secured to the metal support structure via a glass-metal joint.

11. The LADAR sensor system of claim 6, wherein the solderable surface mount layer faces the glass screen.

12. The LADAR sensor system of claim 6, further comprising a wraparound contact layer electrically connecting the solderable surface mount layer to a side of the ceramic substrate opposite the glass screen.

13. The LADAR sensor system of claim 1, wherein the plurality of metallic bumps comprise indium bumps.

14. The LADAR sensor system of claim 1, wherein the readout integrated circuit is connected to a vehicle controller via at least one metallic connector bump.

15. A vehicle sensor system comprising:
a plurality of LADAR sensors, each of said LADAR sensors being configured to detect range within a corresponding field of view and communicate the detected range to a vehicle systems controller; and
wherein each of said LADAR sensors includes a detector array electrically connected to a readout integrated circuit via a plurality of metallic bumps, a glass screen disposed outward of the detector array, a ceramic substrate including a first indention and a conductive solderable surface mount layer, and one of the readout integrated circuit and the detector array being received in the first indention such that an electrical connection between the detector array and the readout integrated circuit is at least approximately level with the conductive solderable surface mount layer.

16. The vehicle sensor system of claim 15, wherein each detector array is hermetically sealed.

17. The vehicle sensor system of claim 15, wherein the vehicle sensor system comprises at least four forward facing LADAR sensors.

18. The vehicle sensor system of claim 17, wherein at least two of the at least four forward facing LADAR sensors are long range sensors and at least two of the at least four forward facing LADAR sensors are short range sensors.

19. The vehicle sensor system of claim 15, wherein the vehicle sensor system includes at least two rear facing LADAR sensors.
